(19) United States
(12) Patent Application Publication
(10) Pub. No.: US 2023/0169502 A1
(43) Pub. Date: Jun. 1, 2023

(54) AUTOMATIC CHARGING CONNECTOR SELECTION

(71) Applicant: Liikennevirta Oy / Virta Ltd, Helsinki (FI)

(72) Inventor: Jussi Ahtikari, Helsinki (FI)

(21) Appl. No.: 17/997,253

(22) PCT Filed: May 26, 2021
(86) PCT No.: PCT/FI2021/050380

§ 371 Date: Oct. 27, 2022

(30) Foreign Application Priority Data
May 28, 2020 (FI) 20205553

(51) Int. Cl. G06Q 20/40

(52) U.S. Cl. CPC G06Q 20/401

(57) ABSTRACT

Various example embodiments generally relate to charging electric devices. An apparatus (200) may receive a payment authorization message, which may be associated with a payment terminal (110). The apparatus (200) may determine a charging station group associated with the payment terminal (110). The apparatus (200) may further receive a status notification comprising an indication of a charging connector (142) of the charging station group being occupied. The apparatus (200) may send a charging command to cause initiation of charging via the charging connector (142), in response to receiving the payment authorization message and the status notification. Example embodiments enable payments to be linked with charging connectors (142) without associated user input at the payment terminal (110). Apparatuses, methods, and computer programs are disclosed.

### TECHNICAL FIELD

Various example embodiments generally relate to the field of charging electric devices. In particular, some example embodiments relate to selecting a connector for charging an electric vehicle.

### BACKGROUND

Popularity of electric vehicles (EV) is increasing rapidly and therefore also demand for charging EVs is increasing. EV charging stations may be connected to cloud-based payment systems that enable a customer to pay for the charging with a mobile application. However, more convenient payment solutions may be desired in some applications.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure enable automatic selection of a charging connector without associated user input at a payment terminal. This and other benefits may be achieved by the features of the independent claims. Further implementation forms are provided in the dependent claims, the description, and the drawings.

According to a first aspect, an apparatus may comprise means for receiving a payment authorization message. The payment authorization message may be associated with a payment terminal. The apparatus may further comprise means for determining a charging station group associated with the payment terminal. The charging station group may comprise one or more charging stations associated with one or more charging connectors. The apparatus may further comprise means for receiving a status notification comprising an indication of a charging connector of the charging station group being occupied. The apparatus may further comprise means for sending a charging command to cause initiation of charging via the charging connector, in response to receiving the payment authorization message and the status notification.

According to an implementation form of the first aspect, the payment authorization message may comprise an identifier of the payment terminal and/or an indication of an authorized payment event with the payment terminal.

According to an implementation form of the first aspect, the apparatus may further comprise means for receiving the payment authorization message from a payment cloud system.

According to an implementation form of the first aspect, the payment authorization message may not comprise an indication of a selected charging station and/or a selected charging connector.

According to an implementation form of the first aspect, the apparatus may further comprise means for determining the charging station group associated with the payment terminal based on a data model comprising a mapping between an identifier of the payment terminal and an identifier of the charging station group.

According to an implementation form of the first aspect, the status notification may comprise an indication of the charging connector transitioning to an occupied state.

According to an implementation form of the first aspect, the status notification may comprise a status notification request message of an open charging point protocol (OCPP).

According to an implementation form of the first aspect, the apparatus may further comprise means for sending the charging command to the charging station.

According to an implementation form of the first aspect, the charging command may comprise an identifier of the charging station and/or an identifier of the charging connector.

According to an implementation form of the first aspect, the charging command may comprise a remote start transaction message of an open charging point protocol (OCPP).

According to an implementation form of the first aspect, the apparatus may further comprise means for refraining from sending the charging command until receiving the payment authorization message, in response to receiving the status notification.

According to an implementation form of the first aspect, the apparatus may further comprise means for receiving a plurality of status notifications associated with a plurality of occupied charging connectors of the charging station group. The apparatus may further comprise means for storing a plurality of time stamps corresponding to the plurality of status notifications. The apparatus may further comprise means for determining the charging connector based on an earliest time stamp for the plurality of occupied charging connectors.

According to a second aspect, a method may comprise receiving a payment authorization message. The payment authorization message may be associated with a payment terminal. The method may further comprise determining a charging station group associated with the payment terminal. The charging station group may comprise one or more charging stations associated with one or more charging connectors. The method may further comprise receiving a status notification comprising an indication of a charging connector of the charging station group being occupied. The method may further comprise sending a charging command to cause initiation of charging via the charging connector, in response to receiving the payment authorization message and the status notification.

According to an implementation form of the second aspect, the payment authorization message may comprise an identifier of the payment terminal and/or an indication of an authorized payment event with the payment terminal.

According to an implementation form of the second aspect, the method may further comprise receiving the payment authorization message from a payment cloud system.

According to an implementation form of the second aspect, the payment authorization message may not comprise an indication of a selected charging station and/or a selected charging connector.

According to an implementation form of the second aspect, the method may further comprise determining the charging station group associated with the payment terminal based on a data model comprising a mapping between an identifier of the payment terminal and an identifier of the charging station group.

According to an implementation form of the second aspect, the status notification may comprise an indication of the charging connector transitioning to an occupied state.

According to an implementation form of the second aspect, the status notification may comprise a status notification request message of an open charging point protocol (OCPP).

According to an implementation form of the second aspect, the method may further comprise sending the charging command to the charging station.

According to an implementation form of the second aspect, the charging command may comprise an identifier of the charging station and/or an identifier of the charging connector.

According to an implementation form of the second aspect, the charging command may comprise a remote start transaction message of an open charging point protocol (OCPP).

According to an implementation form of the second aspect, the method may further comprise refraining from sending the charging command until receiving the payment authorization message, in response to receiving the status notification.

According to an implementation form of the second aspect, the method may further comprise receiving a plurality of status notifications associated with a plurality of occupied charging connectors of the charging station group. The method may further comprise storing a plurality of time stamps corresponding to the plurality of status notifications. The method may further comprise determining the charging connector based on an earliest time stamp for the plurality of occupied charging connectors.

According to a third aspect, a computer program is configured, when executed by an apparatus, to cause the apparatus at least to perform a method according to any implementation form of the second aspect.

According to a fourth aspect an apparatus may comprises at least one processor; and at least one memory including computer program code; the at least one memory and the computer program code configured to, with the at least one processor, cause the apparatus at least to perform a method according to any implementation form of the second aspect.

It is appreciated that the implementation forms described above may be used in combination with each other. Several of the implementation forms may be combined to form a further implementation form.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of an electric vehicle charging system, according to an example embodiment;

FIG. 2 illustrates an example of an apparatus configured to practice one or more example embodiments;

FIG. 3 illustrates an example of an electric vehicle charging system with multiple payment terminals, according to an example embodiment;

FIG. 4 illustrates an example of a payment terminal station group, according to an example embodiment;

FIG. 5 illustrates an example of a data model for a payment terminal station group, according to an example embodiment;

FIG. 6 illustrates an example of a flow diagram for electric vehicle charging, according to an example embodiment;

FIG. 7 illustrates an example of a message sequence and operations for electric vehicle charging, according to an example embodiment; and

FIG. 8 illustrates an example of a method for enabling charging of an electric vehicle, according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

EV charging stations may be connected to cloud-based payment systems to enable customers to pay for the charging for example using a mobile application. Alternatively, physical payment terminals may be applied at the charging stations, for example to enable a user to pay with a debit or credit card. Such payment terminals may enable contactless payment, for example by recognizing the payment card by means of radio frequency identification (RFID), near-field communication (NFC), or other short-range connection. Hence, the payment terminal may not contain buttons or any other user input mechanism. Furthermore, the payment terminal may not be physically coupled to the charging station. For example, the payment terminal and the charging station may be connected to different cloud-based systems. Example embodiments of the present disclosure enable selection of a charging station and/or a charging connector without associated user input at the payment terminal.

For example, a single payment terminal may be linked to a group of charging stations to form a payment terminal station group (PTSG). When a payment is authorized by the payment terminal, a charging point management system (CPMS) may not send a start charging command to any charging station immediately. Instead, the CPMS may wait until the customer connects a charging cable to the a charging connector of the charging station. In response, the charging station sends an indication of an occupied status of the charging connector, for example a StatusNotification OCPP message, to the CPMS. Based on this message the CPMS may determine which station and connector is used and can send start charging command accordingly. It is also possible that the customer first connects the charging cable and only after that shows the payment card to the payment terminal. Therefore, the CPMS may maintain a record of received status notifications of cables connected within the PTSG. The CPMS may determine to start charging on the connector for which it got the first status notification.

According to an example embodiment an apparatus may receive a payment authorization message, which may be associated with a payment terminal. However, the payment authorization message may not comprise an indication of a selected charging station and/or a selected charging connector. The apparatus may determine a charging station group associated with the payment terminal, for example based on a mapping between identifiers of the payment terminal and the charging station group. The apparatus may further receive a status notification comprising an indication of a charging connector of the charging station group being occupied. The apparatus may send a charging command to cause initiation of charging via the charging connector, in response to receiving the payment authorization message and the status notification. Example embodiments enable payments to be linked with charging connectors without associated user input at the payment terminal. Thereby the amount of payment terminals in a charging system may be reduced.

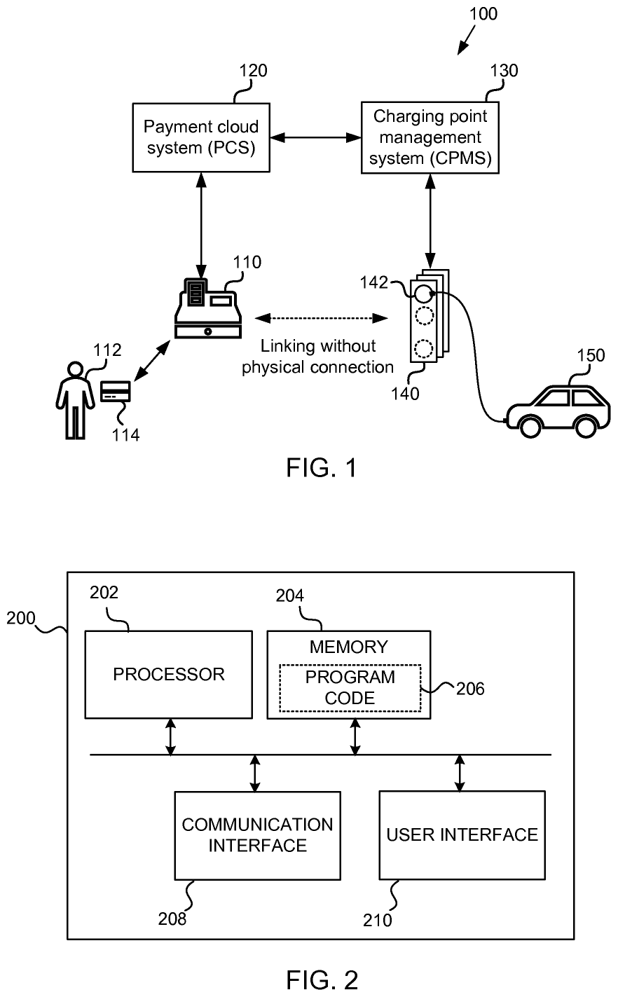

FIG. 1 illustrates an example of an electric vehicle charging system 100, according to an example embodiment. Even though some example embodiments have been described using a car as an example of an EV, it is appreciated that example embodiments may be applied also to other type of EVs, such as for example electric boats or motorcycles, or any other electric devices.

The EV charging system 100 may comprise a payment terminal 110. The payment terminal 110 may be connected to a payment cloud system (PCS) 120 by any suitable communication interface. The payment terminal 110 may detect payment events performed by a customer 112, for example by a payment card 114, key fob, or other contactless payment device. The payment terminal 110 may provide information of a payment event to the payment cloud system 120, which may be configured to authorize the payment, for example to determine whether the payment event is accepted or not.

The EV charging system 100 may further comprise a charging point management system (CPMS) 130, which may be configured to manage one or more charging stations. A charging station 140 may comprise a physical system where an EV 150 can be charged. The charging station 140 may comprise one or more charging connectors 142, which may be considered as electric vehicle supply equipment (EVSE). In general, EVSE may comprise an independently operated and managed part of the charging station that is configured to deliver energy to one EV 150 at a time. Example embodiments enable linking a payment event at the payment terminal 110 to charging station 140 and/or a charging connector 142 without a local (e.g. physical) connection between the payment terminal 110 and the charging station 140. The EV charging system 100 may be configured in accordance with or based on a standard, for example an open charging point protocol (OCPP). It is however appreciated that the example embodiments may be applied in any other current or future electric device charging systems.

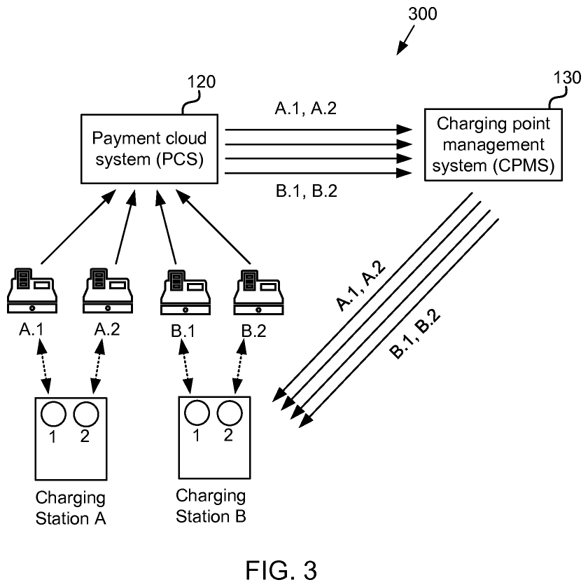

FIG. 2 illustrates an example embodiment of an apparatus 200 configured to practice one or more example embodiments. The apparatus 200 may comprise a computing device such as for example a server. Although apparatus 200 is illustrated as a single device it is appreciated that, wherever applicable, functions of apparatus 200 may be distributed to a plurality of devices.

The apparatus 200 may comprise at least one processor 202. The at least one processor may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus may further comprise at least one memory 204. The memory may be configured to store, for example, computer program code or the like, for example operating system software and application software. The memory may comprise one or more volatile memory devices, one or more non-volatile memory devices, and/or a combination thereof. For example, the memory may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise communication interface 208 configured to enable the apparatus 200 to transmit and/or receive information, to/from other apparatuses. The communication interface 208 may be configured to provide at least one wireless radio connection, such as for example a 3GPP mobile broadband connection (e.g. 3G, 4G, 5G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. Communication interface 208 may comprise, or be configured to be coupled to, at least one antenna to transmit and/or receive radio frequency signals. One or more of the various types of connections may be also implemented as separate communication interfaces, which may be coupled or configured to be coupled to a plurality of antennas. The communication interface may also comprise an internal communication interface within a system, such as for example a data bus.

The apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like. The user interface may be used for example to configure the

When the apparatus 200 is configured to implement some functionality, some component and/or components of the apparatus, such as for example the at least one processor and/or the memory, may be configured to implement this functionality. Furthermore, when the at least one processor is configured to implement some functionality, this functionality may be implemented using program code 206 comprised, for example, in the memory 204.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (CPUs).

The apparatus 200 comprises means for performing at least one method described herein. In one example, the means comprises the at least one processor, the at least one memory including program code configured to, when executed by the at least one processor, cause the apparatus to perform the method.

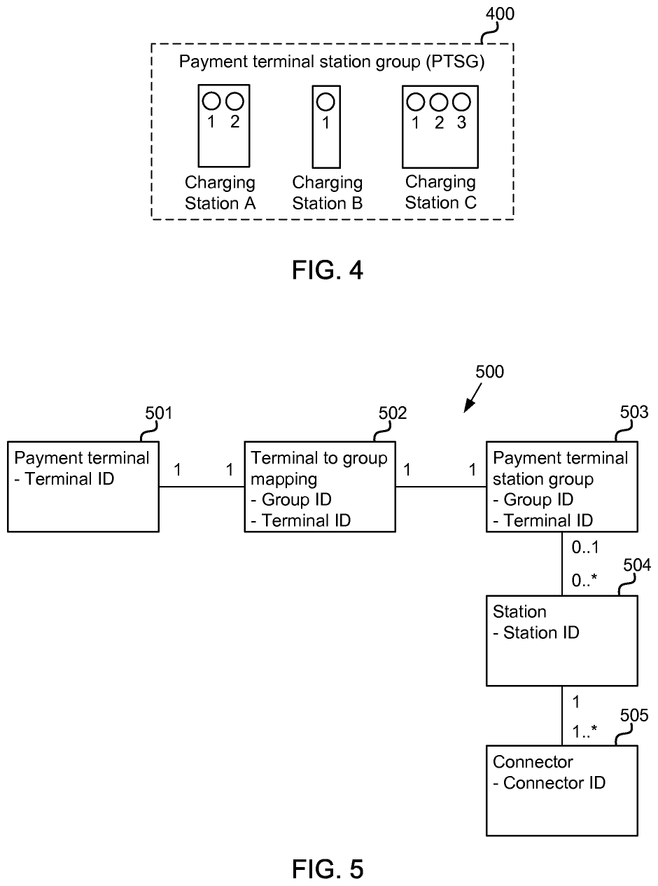

FIG. 3 illustrates an example of an EV charging system 300 with multiple payment terminals, according to an example embodiment. The EV charging system 300 may comprise a PCS 120 and a CPMS 130. The EV charging system 300 may further comprise a plurality of payment terminals (A.1, A.2, B.1, B.2). Each of the payment terminals may be associated with one charging connector. For example, payment terminal A.1 may be associated with charging connector 1 of charging station A and payment terminal B.2 may be associated with charging connector 2 of charging station B. When a customer shows a payment card to payment terminal A.1, the payment may be authorized by the PCS 120. The PCS 120 may inform the CPMS 130 that the payment has been authorized and that it is allowed to start charging on a charging station or a charging connector associated with payment terminal A.1, which in this example is the charging connector 1 of charging station A. In response to obtaining the payment authorization, the CPMS 130 may send a start command to charging station A to initiate charging via charging connector 1 of the charging station A. The CPMS 130 may have stored or have access to information that provides a mapping between a payment terminal and a charging station and/or a charging connector. Therefore, the CPMS 130 may determine to start charging at a particular charging station and/or charging connector without a physical link between the particular payment terminal and the particular charging station and/or connector.

However, the EV charging system 300 may require to associate the start command with information about the exact charging station and the exact charging connector. In that case, it may be necessary to have one-to-one mapping between a payment terminal and a single charging connector of a single charging station, since it may not be possible for the customer to indicate which charging station and/or charging connector to use. For example, if there are three charging stations at the same physical location, three different payment terminals may be needed if the customer is not enabled to select which station and connector to use. Installing unnecessary payment terminals increases the cost of EV charging systems and therefore it may be desired to provide a single payment terminal for all or multiple charging stations and/or charging connectors at the same location.

Using a single payment terminal may be enabled for example based on a local non-cloud connection between a payment terminal and a charging station. One solution is to have physical integration between the payment terminal and the charging station. The payment terminal may be configured to authorize charging connectors of a charging station locally through a physical connection, which may be independent of any EV charging protocol, for example OCPP. However, this solution may apply a special hardware connection between the payment terminal and the charging station and therefore alternative solutions may be applied to enable using single payment terminal with different station models from different manufacturers.

Another solution is to indicate that charging is allowed for all connectors of a charging station. This may be implemented for example based on indicating connector number “0” in a charging command, for example a start charging message of the OCPP protocol. The charging station may be configured to interpret a charging command for connector “0” as an authorization to start charging for any charging connector of the charging station. However, all charging stations may not be configured to support this option. Furthermore, while this solution may be used for a single charging station, other solutions may be applied to enable using a single payment terminal with several charging stations at the same location.

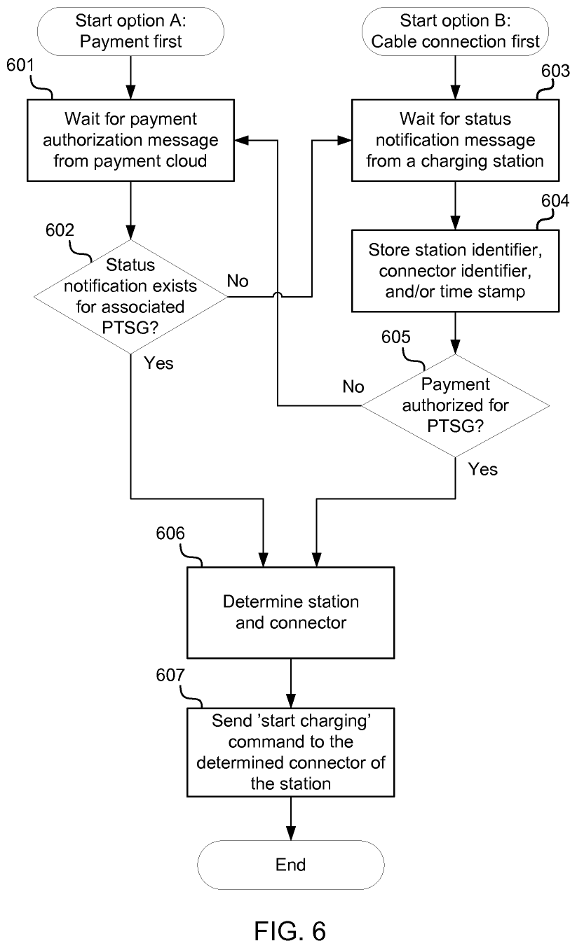

FIG. 4 illustrates an example of a payment terminal station group (PTSG) 400, according to an example embodiment. The PTSG 400 may comprise one or more charging stations, for example charging stations A, B, and C. The PTSG 400 may further comprise one or more charging connectors. Each charging station may comprise one or more charging connectors. For example, charging station A may comprise two charging connectors (1,2), charging station B may comprise one charging connector (1), and charging station C may comprise three charging connectors (1,2,3). Charging stations A, B, C, and/or their respective charging connectors may be associated with the PTSG 400. PTSG 400 may be also referred to as a charging station group, a station group, or simply a group.

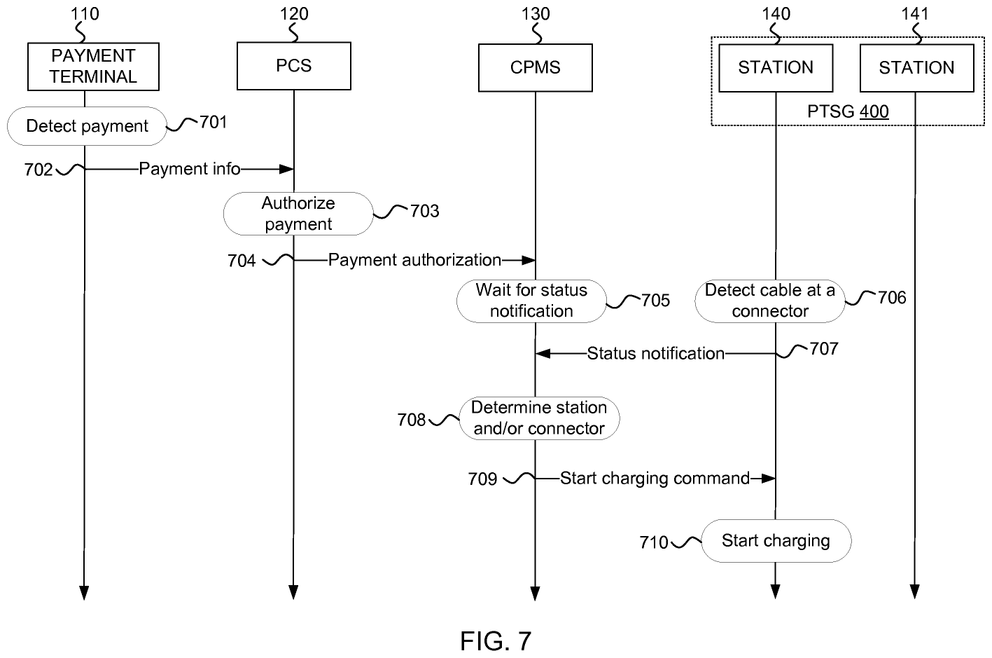

FIG. 5 illustrates an example of a data model 500 for a payment terminal station group, according to an example embodiment. The data model 500 enables grouping a plurality of charging stations to a group linked to a single payment terminal. The data model 500 may comprise a plurality of objects. The objects may be associated with each other according to predetermined rules. The data model 500 may comprise a payment terminal object 501. The payment terminal object 501 may comprise a terminal identifier (ID), which may identify a payment terminal. The data model 500 may further comprise a terminal-to-group mapping object 502, for example a table linking a payment terminal to a payment terminal station group (PTSG). The terminal-to-group mapping object 502 may therefore comprise a group identifier of a PTSG and a terminal identifier of a payment terminal. The payment terminal object 501 may have a one-to-one mapping with the terminal-to-group mapping object 502. The payment terminal object 501 may be therefore associated with one terminal-to-group mapping object 502. A terminal-to-group mapping object 502 may be associated with one payment terminal object 501.

The data model 500 may further comprise a payment terminal station group (PTSG) object 503. The PTSG object 503 may comprise a group identifier and a terminal identifier. The group identifier may identify a PTSG. The terminal identifier may identify a payment terminal associated with the PTSG. The PTSG object 503 may have one-to-one mapping with the terminal-to-group mapping object 502. A PTSG object 503 may be further associated with zero or more station objects 504.

The station object 504 may comprise a station identifier, which may identify a charging station. A station object 504 may be associated with zero or one PTSG object 503. Hence, a charging station may be associated with one PTSG or the charging station may not be associated with any PTSG.

The data model 500 may further comprise a connector object 505. The connector object 505 may comprise a connector identifier, which may identify a charging connector. The station object 504 and connectors object may have a one-to-many relationship. For example, one charging station may be associated with one or more charging connectors. A charging connector may be associated with one charging station. The connector identifier may be unique within an associated station object 504. Alternatively, the connector identifier may be unique within a PTSG object 503. This may enable addressing charging connectors independent of the associated charging station. A charging connector may be associated with a PTSG via an association to a charging station.

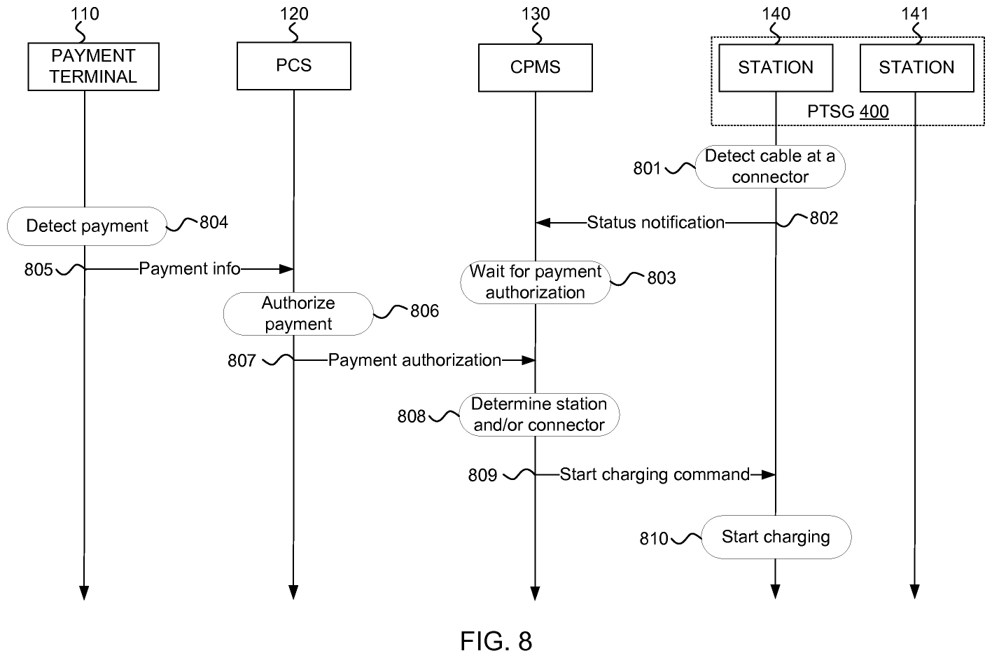

FIG. 6 illustrates an example of a flow diagram for EV charging, according to an example embodiment. The procedure of FIG. 6 may be executed at CPMS 130, or another device or entity. The procedure may be started either by payment (Start option A) or connecting a charging cable to the EV 150 (Start option B). This ensures that the customer 112 can be properly served regardless of his/her behaviour at the charging station 140.

At 601, the CPMS 130 may wait for a payment authorization message from a payment cloud, for example PCS 120. This operation may be entered for example if the customer 112 pays for the charging before connecting the charging cable. At some point, the CPMS 130 may receive a payment authorization message. The payment authorization message may be associated with the payment terminal 110. The payment authorization message may for example comprise an identifier of the payment terminal 110. The payment authorization message may further comprise an indication of an authorized payment event with the payment terminal 110. However, the payment authorization message may not comprise an indication of a selected charging station and/or a selected charging connector. For example, the payment terminal 110 may not enable a customer to select a charging station and/or a charging connector. The CPMS 130 may therefore determine a PTSG associated with the payment terminal 110 based on a data model comprising a mapping between an identifier of the payment terminal 110 and an identifier of the PTSG, for example based on the terminal-to-group mapping object 502. As discussed above, the PTSG may comprise one or more charging stations associated with one or more charging connectors. Determining the associated PTSG may be in response to receiving the payment authorization message and/or in response to determining that the payment authorization message comprises a payment terminal identifier. In response to receiving the payment authorization message, the CPMS 130 may move to operation 602.

At 602, the CPMS 130 may determine whether a status notification exists for a PTSG associated with the payment terminal 110. In particular, the CPMS 130 may determine whether there is a status notification, for example a status notification message, that indicates a charging connector associated with the PTSG to be occupied. Current status of a charging connector may be determined based on a latest status notification for the respective charging connector. The CPMS 130 may determine whether a connector is occupied based on the status notification message. A status notification may comprise an indication that a charging cable is connected to a charging connector. A status notification may comprise a status notification message or other type of indication of the status of the charging connector. A status notification may for example comprise an indication of a charging connector transitioning or having transitioned to an occupied status. The status notification may therefore comprise an indication of a change of the charging connector status, for example from an ‘available’ status to an ‘occupied’ status. A status notification may comprise an identifier of a charging station and/or identifier(s) of one or more charging connectors. If no status notification exists or latest status notification(s) do not indicate an occupied status for any of the charging connectors associated with the PTSG, the CPMS 130 may move to operation 603 and wait for a charging connector to be occupied. If at least one status notification exists or latest status notification(s) indicate an occupied status for at least one charging connector of the PTSG, the CPMS 130 may move to operation 606.

At 603, the CPMS 130 may wait for a status notification from charging station(s) associated with the PTSG 400. At some point, the CPMS 130 may receive a status notification comprising an indication of a charging connector of the PTSG being occupied.

At 604, for example in response to receiving the status notification indicating the occupied status for a charging connector of the PTSG, the CPMS 130 may store the corresponding station identifier and/or connector identifier. The station identifier and/or the connector identifier may be included in the received status notification. The status notification may further comprise a timestamp. The timestamp may indicate a time for which the status is reported. The CPMS 130 may store the timestamp. If the status report message does not include a timestamp, the CPMS 130 may store and use a reception time of the status notification instead of the timestamp.

At 605, the CPMS 130 may determine whether an authorized payment exists for the PTSG associated with the charging station. If the procedure started from Start option A, the answer is ‘Yes’ and the CPMS 130 may move to operation 606. However, if the procedure started by connecting a charging cable to the EV 150 (Start option B), the CPMS 130 may first perform operations 603 and 604 to receive the status notification and store the station identifier, the connector identifier, and/or the timestamp, as described above. In this case, no authorized payment may exist for the PTSG associated with the charging station 140 and/or the charging connectors, and therefore the CPMS 130 may move to operation 601 to wait for the payment authorization message. Once the payment authorization message is received, the CPMS 130 may determine at 602 that also the desired status notification exists, and move to operation 606.

At 606, the CPMS 130 may determine a charging station and/or charging connector, for example based on the information about the authorized payment for the PTSG and the status notification indicating an occupied charging connector. If there's only one status notification indicating an occupied charging connector, the CPMS 130 may select the occupied charging connector. However, it is possible that the CPMS 130 receives a plurality of status notifications associated with a plurality of occupied charging connectors of the PTSG. In this case, the CPMS 130 may store a plurality of timestamps corresponding to the plurality of status notifications. The CPMS 130 may further determine the charging connector based on an earliest timestamp for the plurality of occupied charging connectors. An authorized payment may be associated with the determined charging connector. For example, if multiple customers 150 appear at a charging station 140 simultaneously and connect their charging cables, a first authorized payment may be associated with a charging connector for which the first status notification indicating an occupied status was received.

At 607, the CPMS 130 may send a charging command to cause initiation of charging via the charging connector. Sending the charging command may be in response to receiving the payment authorization message and the status notification. The CPMS 130 may send the charging command to the charging station 140. Alternatively, the charging command may be sent to an intermediary device, for example local proxy or a local controller for delivery to the charging station 140. The charging command may comprise an identifier of the charging station and/or an identifier of the charging connector. The charging command may comprise or be transmitted as a remote start transaction message, for example in accordance with the OCCP protocol. The charging command may comprise or be interpreted as instructions to start charging via the associated charging connector. The above procedure enables to control charging such that charging is not started unless there's an authorized payment for the PTSG associated with the received status notification. Therefore, in response to receiving the status notification, the CPMS 130 may refrain from sending the charging command until receiving the payment authorization message.

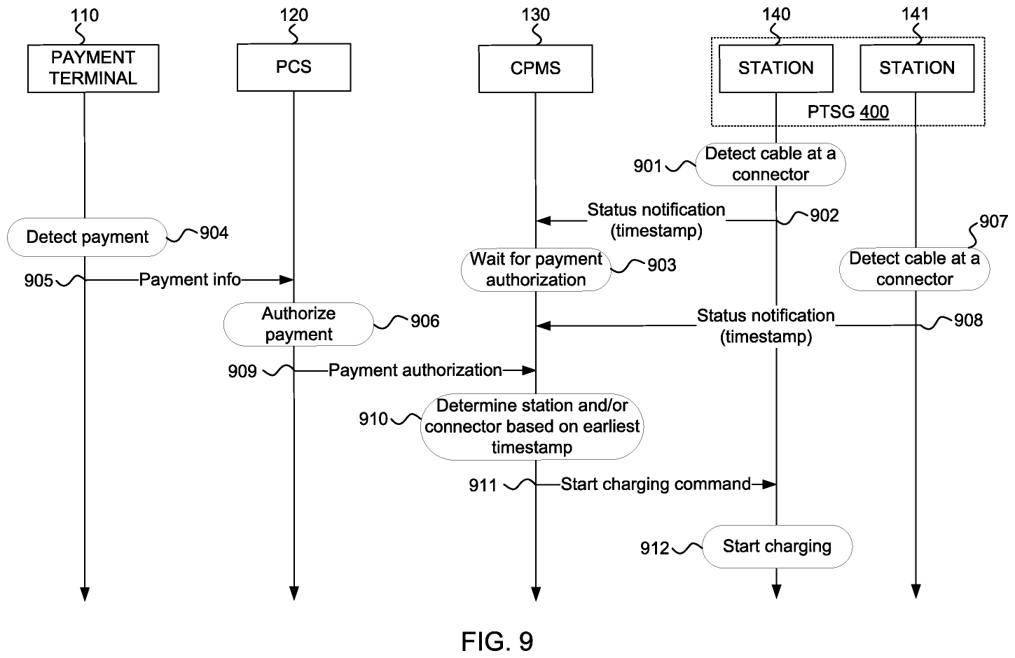

FIG. 7 illustrates an example of a message sequence and operations for EV charging, according to an example embodiment. The procedure of FIG. 7 may be initiated when a payment is received before connecting a charging cable to a charging connector, corresponding to Start option 1 of FIG. 6.

At 701, the payment terminal 110 may detect a payment event.

At 702, the payment terminal 110 may send any relevant information associated with the payment event to the PCS 120.

At 703, the PCS 120 may authorize the payment based on the information received from the payment terminal 110.

At 704, the PCS 120 may send a payment authorization message to the CPMS 130. As discussed above, the payment authorization message may comprise an identifier of the payment terminal 110 or an indication of an authorized payment event with the payment terminal 110. However, the payment authorization message may not comprise an indication of a selected charging station and/or a selected charging connector. The CPMS 130 may receive the payment authorization message. Even though the payment authorization message is illustrated as a single message, it is appreciated that corresponding information may be divided between multiple control messages.

At 705, the CPMS 130 may wait for a status notification from a charging station of an associated PTSG 400. The CPMS 130 may determine the associated PTSG 400 based on the information included in the payment authorization message and/or a mapping between the payment terminal 110 and the PTSG 400. At this point, the CPMS 130 may refrain from determining a charging connector for charging and/or sending a charging command to any charging station.

At 706, charging station 140 may detect that a cable has been connected to one of its charging connectors. In general, the charging station 140 may determine that a charging connector is occupied. The charging station 140 may belong to PTSG 400.

At 707, the charging station 140 may send a status notification indicating that a charging connector is occupied. The status notification may comprise a status notification message of an open charging point protocol (OCPP), for example a status notification request message. The CPMS 130 may receive the status notification.

At 708, the CPMS 130 may determine a charging station and/or a charging connector based on the received status notification and the previously received payment authorization for PTSG 400. The CPMS 130 may select a charging connector for which a status notification indicating an occupied status has been received. For example, charging connectors of charging stations 140 and 141 associated with PTSG 400 may initially have an ‘available’ status. The status notification may indicate that one charging connector of charging station 140 has transitioned to an ‘occupied’ status. Accordingly, the CPMS 130 may select the charging station with the occupied charging connector.

At 709, the CPMS 130 may send a start charging command to the determined charging station 140. The charging command may comprise an identifier of the occupied charging connector. The charging station 140 may receive the start charging command.

At 710, the charging station 140 may start charging, for example in response to receiving the charging command. The charging station 140 determine to initiate charging via the charging connector indicated in the charging command. This example embodiment enables a detected payment to be linked with a correct charging connector of PTSG 400.

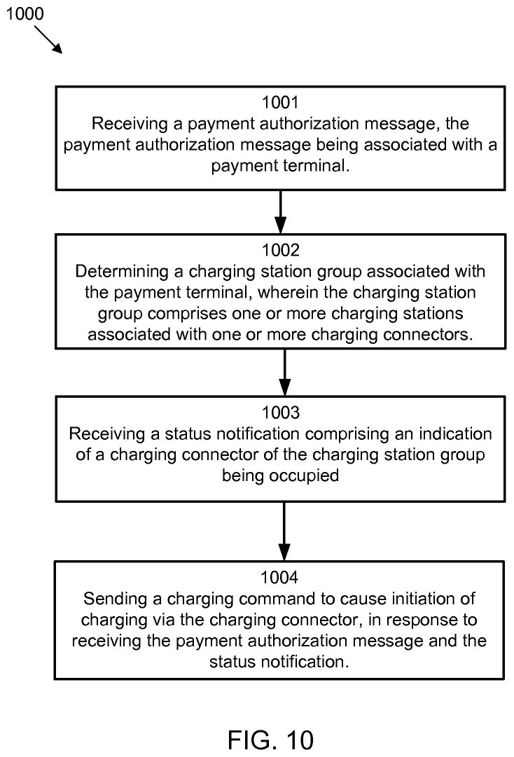

FIG. 8 illustrates an example of a message sequence and operations for EV charging, according to an example embodiment. The procedure of FIG. 8 may be initiated when a charging cable has been connected to a charging connector before making a payment, corresponding to Start option 2 of FIG. 6.

At 801, the charging station 140 may detect a charging cable at a charging connector, similar to operation 706.

At 802, the charging station 140 may send a status notification, similar to 707.

At 803, the CPMS 130 may wait for payment authorization for PTSG 400. Meanwhile, the CPMS 130 may refrain from sending a start charging command to charging station 140.

At 804 and 805, the payment terminal 110 may detect a payment event and send information about the payment event to PCS 120, similar to 701 and 702.

At 806 and 807, the PCS 120 may authorize the payment and send a payment authorization message, similar to 703 and 704.

At 808, the CPMS 130 may determine a charging station and/or a charging connector based on the received payment authorization and the previously received status notification for PTSG 400. The CPMS 130 may select a charging connector for which a status notification indicating an occupied status was received before receiving the payment authorization for PTSG 400.

At 809, the CPMS 130 may send a start charging command to the determined charging station 140, similar to 709.

At 809, the charging station 140 may initiate charging via the determined charging connector, similar to 710. This example embodiment enables to link a payment with a correct charging connector of PTSG 400, if the customer 150 connects the charging cable before payment.

At 810, the charging station 140 may start charging, similar to 710.

FIG. 9 illustrates an example of a message sequence and operations for EV charging, according to an example embodiment. The procedure of FIG. 9 may be initiated when a charging cable is connected before making a payment, corresponding to Start option 2 of FIG. 6. Subsequently, another charging cable may be connected to a charging connector associated with the same PTSG.

At 901, the charging station 140 may detect a charging cable at a charging connector, similar to 706.

At 902, the charging station 140 may send a status notification, similar to 707. The status notification may comprise a timestamp. The timestamp may indicate a time of status change for a charging connector. The CPMS 130 may receive the status notification and store the timestamp. The CPMS 130 may also store other information included in the status notification, such as for example an identifier of the charging station 140 or the charging connector.

At 903, the CPMS 130 may wait for payment authorization for PTSG 400, similar to 803.

At 904 and 905, the payment terminal 110 may detect a payment event and provide information of the payment event to PCS 120, similar to 701 and 702.

At 906, the PCS 120 may authorize the payment, similar to 703.

At 907 and 908, another charging station 141 may detect a charging cable at a charging connector and send a status notification to the CPMS 130. The status notification may comprise a timestamp, as discussed above. The CPMS 130 may receive the status notification from the other charging station 141. The status notification may be received before receiving a payment authorization message associated with PTSG 400. In general, CPMS 130 may receive a plurality of status notifications associated with a plurality of occupied charging connectors of the PTSG 400. The plurality of status notification messages may be received before receiving a payment authorization message associated with PTSG 400. It is however noted that one or more payment authorization messages may have been previously received and handled by CPMS 130. The CPMS 130 may store a plurality of time stamps corresponding to the plurality of status notifications.

At 909, the CPMS 130 may receive a payment authorization message indicating a successful payment event with payment terminal 110. The CPMS 130 may determine that the payment authorization message is associated with PTSG 400, for example based on association of the payment terminal 100 and the PTSG 400 in the data model 500.

At 910, may determine a charging station and/or charging connector associated with the payment event. Since there are two cables connected at PTSG 400, the CPMS 130 may determine which cable connector is associated with the payment event. For example, the CPMS 130 may determine the charging connector based on an earliest time stamp for the plurality of occupied charging connectors. In the example of FIG. 9 the status notification form charging station 140 has an earlier time stamp compared to the timestamp of the status notification from the other charging station 141. Therefore, the CPMS 130 may select the indicated charging connector of charging station 140.

It is noted that even though the two status notifications of FIG. 9 are received from different charging stations, it is also possible that the CPMS 130 receives multiple status notifications from a single charging station, the status notifications being associated with different charging connectors of the single charging station. The status notifications may be received in a single status notification message or the status notifications for different charging connectors may be received in separate status notification messages. A similar approach for selecting a charging connector within a charging station may be applied.

At 911, the CPMS 130 may send a charging command to the determined charging station or the charging station associated with the determined charging connector, similar to 709. In this example, the charging command is sent to charging station 140.

At 912, the charging may be initiated at the determined connector of charging station 140.

This example embodiment enables to link a payment event to a charging connector even if there are multiple customers occupying multiple charging connectors.

FIG. 10 illustrates an example of a method for enabling charging of an electric vehicle, according to an example embodiment.

At 1001, the method may comprise receiving a payment authorization message. The payment authorization message may be associated with the payment terminal.

At 1002, the method may comprise determining a charging station group associated with the payment terminal. The charging station group may comprise one or more charging stations associated with one or more charging connectors.

At 1003, the method may comprise receiving a status notification comprising an indication of a charging connector of the charging station group being occupied.

At 1004, the method may comprise sending a charging command to cause initiation of charging via the charging connector. The charging command may be sent in response to receiving the payment authorization message and the status notification.

Further features of the method(s) directly result for example from functionalities of the CMPS 130 and other devices, as described throughout the specification and in the appended claims. Different variations of the method(s) may be also applied, as described in connection with the various example embodiments.

An apparatus, may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item, ‘at least one’ item, and ‘one or more’ items may refer to one or more of those items or a plurality of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including computer program code, the at least one memory and the computer program code configured to, with the at least one processor, cause the apparatus at least to:
receive a status notification comprising an indication of a charging connector of a charging station group being occupied;
receive a payment authorization message, the payment authorization message being associated with a payment terminal;
determine, based on a data model comprising a mapping between an identifier of the payment terminal and an identifier of the charging station group, the charging station group being associated with the payment terminal, wherein the charging station group comprises one or more charging stations associated with one or more charging connectors; and
send a charging command to cause initiation of charging via the charging connector, in response to receiving the payment authorization message and the status notification.

2. The apparatus according to claim 1, wherein the payment authorization message comprises at least of an identifier of the payment terminal and an indication of an authorized payment event with the payment terminal.

3. The apparatus according to claim 1, wherein the computer program code is further configured to, with the at least one processor, cause the apparatus to:
receive the payment authorization message from a payment cloud system.

4. The apparatus according to claim 1, wherein the payment authorization message does not comprise at least one of an indication of a selected charging station and a selected charging connector.

5. The apparatus according to claim 1, wherein the status notification comprises an indication of the charging connector transitioning to an occupied state.

6. The apparatus according to claim 1, wherein the status notification comprises a status notification request message of an open charging point protocol (OCPP).

7. The apparatus according to claim 1, wherein the computer program code is further configured to, with the at least one processor, cause the apparatus to:
send the charging command to the one or more charging stations.

8. The apparatus according to claim 1, wherein the charging command comprises at least one of an identifier of a selected charging station of the one or more charging stations and an identifier of the charging connector.

9. The apparatus according to claim 1, wherein the charging command comprises a remote start transaction message of an open charging point protocol (OCPP).

10. The apparatus according to claim 1, wherein the computer program code is further configured to, with the at least one processor, cause the apparatus to:
refrain from sending the charging command until receiving the payment authorization message, in response to receiving the status notification.

11. The apparatus according to claim 1, wherein the computer program code is further configured to, with the at least one processor, cause the apparatus to:
receive a plurality of status notifications associated with a plurality of occupied charging connectors of the charging station group;
store a plurality of time stamps corresponding to the plurality of status notifications; and
determine the charging connector based on an earliest time stamp for the plurality of occupied charging connectors.

12. A method, comprising:
receiving a status notification comprising an indication of a charging connector of a charging station group being occupied;
receiving a payment authorization message, the payment authorization message being associated with a payment terminal;
determining, based on a data model comprising a mapping between an identifier of the payment terminal and an identifier of the charging station group, the charging station group being associated with the payment terminal, wherein the charging station group comprises one or more charging stations associated with one or more charging connectors; and
sending a charging command to cause initiation of charging via the charging connector, in response to receiving the payment authorization message and the status notification.

13. The method according to claim 12, wherein the payment authorization message comprises at least one of an identifier of the payment terminal and an indication of an authorized payment event with the payment terminal.

14. The method according to claim 12, further comprising:
receiving the payment authorization message from a payment cloud system.

15. The method according to claim 12, wherein the payment authorization message does not comprise at lease one of an indication of a selected charging station and a selected charging connector.

16. The method according to claim 12, wherein the status notification comprises an indication of the charging connector transitioning to an occupied state.

17. The method according to claim 12, wherein the status notification comprises a status notification request message of an open charging point protocol (OCPP).

18. The method according to claim 12, further comprising: sending the charging command to the one or more charging stations.

19. The according to claim 12, wherein the charging command comprises at least one of an identifier of the one or more charging stations and an identifier of the charging connector.

20. A computer program comprising program code configured to cause an apparatus at least to:
receive a status notification comprising an indication of a charging connector of a charging station group being occupied;
receive a payment authorization message, the payment authorization message being associated with a payment terminal;
determine, based on a data model comprising a mapping between an identifier of the payment terminal and an identifier of the charging station group, the charging station group being associated with the payment terminal, wherein the charging station group comprises one or more charging stations associated with one or more charging connectors; and
send a charging command to cause initiation of charging via the charging connector, in response to receiving the payment authorization message and the status notification.
